(19) United States
(12) Patent Application Publication
(10) Pub. No.: US 2016/0323647 A1
(43) Pub. Date: Nov. 3, 2016

(54) VIDEO SHARING METHOD AND SYSTEM IN SMART TV

(71) Applicants: LE HOLDINGS (BEIJING) CO., LTD., Beijing (CN); LE SHI ZHI XIN ELECTRONIC TECHNOLOGY (TIAN JIN) LIMITED, Beijing (CN)

(72) Inventors: Lei Yan, Beijing (CN); Shuyin DU, Beijing (CN)

(21) Appl. No.: 15/107,514

(22) PCT Filed: Dec. 17, 2014
(86) PCT No.: PCT/CN2014/094037

§ 371 Date: Jun. 23, 2016

(30) Foreign Application Priority Data
Dec. 23, 2013 (CN) 201310715636X

(51) Int. Cl. H04N 21/4788; H04N 21/431; G11B 27/10; H04N 21/858; H04N 21/61; H04N 21/845

(52) U.S. Cl. CPC H04N 21/4788; H04N 21/6125; H04N 21/8456; G11B 27/10; H04N 21/858; H04N 21/4312

(57) ABSTRACT

A video sharing method and system in smart TV, the method comprising: in the process of playing a video by a smart TV, receiving a control instruction to intercept the currently playing video, the control instruction comprising an intercept start instruction and an intercept end instruction to intercept the currently playing video; according to the playback progress of the current video upon receipt of the intercept start instruction and the intercept end instruction, acquiring the start time and the end time of the intercepted video clip in the current video; uploading the identification information of the current video and the start time and the end time to a server, such that the server generates a shared link about the intercepted video clip, and provides the shared link for a user. The present method can share the link of any highlight in a video program played on a smart TV, thus improving the convenience and flexibility of video sharing in the smart TV.

### FIELD OF TECHNOLOGY

The present application relates to the field of smart TVs and particularly to a video sharing method and system in a smart TV.

### BACKGROUND

Under the circumstances that PCs have been intelligent, and mobile phones and tablet computers also have been intelligent on a large scale, in order to conform to the trend of “high definition”, “networking” and “intelligence” of TVs, smart TVs have gradually come into our lives.

The so-called smart TVs, just like smart phones, have full-open platforms and are designed to run operating systems; users can install and uninstall programs such as application software and games provided by TV manufacturers or third-party service providers by themselves while watching common TV contents; with such programs, the functions of the smart TVs can be continuously extended and upgraded; moreover, the smart TVs can be connected to networks, AV devices, PCs and the like, and can obtain program contents from a plurality of channels such as the networks, the AV devices, the PCs and the like; the contents most needed by the users can be clearly displayed on TV screens by an easy-to-use integrated operation interface.

In a traditional video program providing mode, the provided video programs are irreproducible. Although some TV video programs can be repeated, TV video programs are often played at fixed time and fixed channels; when a user finds a favorite wonderful video program and hopes to share it with friends during watching video programs by TV, the user can share the play message of the video program with friends only by manually notifying the friends, and the notified friends can only switch to the channel immediately to watch the video program at the moment. That is to say, in a traditional TV system, the means of sharing wonderful video programs with friends cannot be provided. Hence, a problem to be urgently solved by those skilled in the art is to provide a method of sharing a wonderful video program watched currently with others in a smart TV, thereby sharing the watched wonderful video timely with the others.

### SUMMARY

A purpose of a video sharing method and system in a smart TV is to share any wonderful clip of a video program played in a smart TV with a link, thereby improving the convenience and flexibility of video sharing in the smart TV.

To achieve the above purpose, according to one aspect of embodiments of the present application, a video sharing method in a smart TV is provided, including:
during the course of playing a video in the smart TV, receiving a control instruction of extracting a video clip from currently playing video, wherein the control instruction includes an extracting start instruction and an extracting end instruction to extract a video clip from the currently playing video;
according to the playback progress of the currently playing video when receiving the extracting start instruction and the extracting end instruction, acquiring a start time and an end time of an extracted video clip in the currently playing video;
uploading the identity information of the currently playing video and the start time and the end time to a server, so that the server generates a shared link about the extracted video clip, and provides the shared link for a user.

Preferably, the server generating the shared link about the extracted video clip includes:
finding out, by the server, the data content of the currently playing video according to the identity information of the currently playing video;
extracting the data content corresponding to the video clip from the data content of the currently playing video according to the start time and the end time and generating a video clip file;
generating an access address for the video clip file according to a preset address generation rule and generating a shared link of the video clip file based on the access address.

Preferably, if the existence time, from the moment of generation, of the video clip file exceeds a preset duration threshold, the video clip file is deleted from the server.

Preferably, the server generating the shared link about the extracted video clip includes:
determining, by the server, a link of the currently playing video according to the identity information of the currently playing video;
splicing the start time and the end time into the link of the currently playing video to generate the shared link about the extracted video clip.

Preferably, the method further includes:
playing a video from a video frame corresponding to the start time to a video frame corresponding to the end time when the link, which the start time and end time are spliced into, of the video is clicked at a client of a sharing recipient.

Preferably, the method further includes:
during playing the video from the video frame corresponding to the start time, if a request for playing the complete video from the beginning is received, playing the complete video from the beginning frame of the video.

Preferably, after the shared link is generated, the server returns the shared link to a client of a sharing provider, the method further including:
after the shared link returned by the server is received, displaying a friend user list of current user;
after the current user chooses a target friend user, displaying the shared link in a pop-up dialog box so that the shared link is sent to the target friend user by a message system.

Correspondingly, a video sharing system in a smart TV is provided, including:
an instruction receiving module configured to receive a control instruction of extracting a video clip from currently playing video during the course of playing a video in the smart TV, wherein the control instruction includes an extracting start instruction and an extracting end instruction to extract a video clip from the currently playing video;
a time point acquiring module configured to acquire a start time and an end time of an extracted video clip in the currently playing video according to the playback progress of the currently playing video when receiving the extracting start instruction and the extracting end instruction; and
an extracting information uploading module configured to upload the identity information of the currently playing video and the start time and the end time to a server, so that the server generates a shared link about the extracted video clip, and provides the shared link for a user.

Preferably, a server included in the system includes:
a link generation module configured to generate the shared link about the extracted video clip at the server;
the link generation module includes:
a video finding out module configured to find out the data content of the currently playing video according to the identity information of the currently playing video;
a video clip generation module configured to extract the data content corresponding to the video clip from the data content of the currently playing video according to the start time and the end time and generate a video clip file; and
a first link generation module configured to generate an access address for the video clip file according to a preset address generation rule and generate a shared link of the video clip file based on the access address.

Preferably, a server included in the system includes:
a link generation module configured to generate the shared link about the extracted video clip at the server;
the link generation module includes:
a current video link determination module configured to determine a link of the currently playing video according to the identity information of the currently playing video; and
a second link generation module configured to splice the start time and the end time into the link of the currently playing video to generate the shared link about the extracted video clip.

The embodiments of the present application further disclose a computer readable storage medium on which a program for executing the above-mentioned method is recorded.

With the video sharing method and system in a smart TV, any video clip of a video program played in a smart TV can be shared with a link, and the convenience and flexibility of video sharing in a smart TV are improved.

### BRIEF DESCRIPTION OF THE DRAWINGS

In order to describe more clearly the technical solutions of the embodiments of the present application or in the prior art, the drawings needing to be used in the embodiments will be described below briefly; and evidently the drawings described below are merely illustrative of some embodiments of the present application, and those ordinary skilled in the art can derive other drawings from these drawings without any inventive effort.

FIG. 1 illustrates a flow chart of a video sharing method in a smart TV according to an embodiment of the present application;

FIG. 2 illustrates a schematic diagram of a video sharing system in a smart TV according to an embodiment of the present application.

### DETAILED DESCRIPTION OF THE EMBODIMENTS

in order to make the above objects, technical features and advantages of the embodiments of the present application more apparent, the embodiments of the present application will be further described below clearly and fully with reference to the drawings and detailed description of the embodiments.

After TV devices have developed to intelligent stage, smart TV control modes may not be limited to a traditional control mode only, in which a smart TV is controlled by remote controller; in practical application, more peripheral devices can be utilized for interconnection and intercommunication with a smart TV and used for controlling a smart TV more conveniently, and a mobile communication terminal device is one of peripheral devices. In the embodiments of the present application, an application (APP) running on a mobile communication terminal device can be provided; for example, it can be named as a “TV assistant” and a user can install the APP in his mobile terminal device; correspondingly, a corresponding background application can be installed in an operating system at video playback device side to interact with the TV assistant at mobile terminal device side and realize a corresponding function of cache cleanup. Under the circumstances that a TV assistant is installed in a mobile communication terminal device and the corresponding background application is provided in a video playback device, the video playing device and the mobile communication terminal device are connected to the same local area network, for example, connected to a network via the same WIFI (Wireless Fidelity). In this way, the TV assistant in the mobile communication terminal can establish a communication connection with the video playback device in a private communication protocol; subsequent signal and data transmission and the like are all implemented on the communication connection.

Specifically, after the communication connection is established between a mobile communication terminal and a video playback device through certain port, each background application (it is possible that a plurality of applications are installed in the video playback device, and it is possible that multiple applications run simultaneously in the background to achieve respective functions, wherein the application for carrying out the operation of cleanup cache is included) at video playback device side can monitor messages received on the port. A specific message interaction process can be realized as follows: after a message is sent from mobile communication terminal device side to video playback device side, the operating system at video playing device side will receive the message and broadcast the message to each background application in the video playback device; after each background application receives the message, it can determine whether the message needs to be processed by itself, and if not, the message can be discarded, and otherwise, subsequent operations, such as parsing, are carried out.

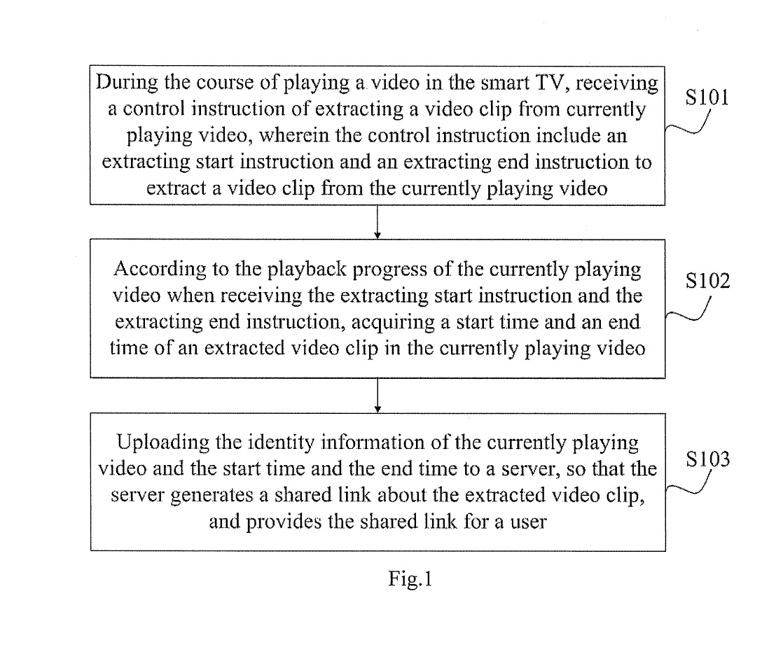

Referring to FIG. 1, a flow chart of a video sharing method in a smart TV according to the embodiments of the present application is illustrated. As illustrated in FIG. 1, the method can include the following steps:

S101: during the course of playing a video in the smart TV, receiving a control instruction of extracting a video clip from currently playing video, wherein the control instruction include an extracting start instruction and an extracting end instruction to extract a video clip from the currently playing video.

With the development of the manufacturing technology of smart TVs and continuous improvement of the hardware specifications and the intelligent levels of smart TVs, the existing smart TVs may not be limited to the control mode any more, in which smart TV is controlled by remote controller traditional remote controller; in the course of using smart TVs, other peripheral devices can be used for controlling smart TVs and also can interact with smart TVs; the peripheral devices may include smart mobile communication devices, pads and the like. When these peripheral devices are used, APPs, like TV assistant, can be installed in them to control or interact with smart TVs. Program sources of smart TVs can not only be programs of traditional broadcast/TV network, but also be TV programs provided by Internet servers with which smart TVs connect through internet.

In the method according to the embodiments of the present application, firstly, during the course of playing a video program in a smart TV, the control instruction of extracting a video clip from currently playing video can be received at any moment. The control instruction of extracting a video clip may include an extracting start instruction and an extracting end instruction to extract a video clip from the currently playing video. When the playing of a smart TV is controlled by a peripheral device, a button for extracting a video clip from currently playing video, such as an extracting button or a combination of a pair of extracting buttons can be set on the peripheral control device. When the user watches a TV video and finds out that a video clip is wonderful, a control instruction of extracting a video clip from the TV video can be sent to the smart TV by pressing down the extracting button/combination of a pair of extracting buttons on the peripheral device.

S102: according to the playback progress of the currently playing video when receiving the extracting start instruction and the extracting end instruction, acquiring a start time and an end time of an extracted video clip in the currently playing video.

After the control instruction of extracting a video clip from the currently playing video is received by the smart TV, the start time and the end time of an extracted video clip in the currently playing video can be acquired according to the playback progress of the currently playing video when receiving the extracting start instruction and the extracting end instruction. The playback progress of the currently playing video can be point-in-time of playing of the currently playing video, namely, the so-called start time and end time, which are relative to the playback progress of the currently playing video. For example, the total duration of a video played on a smart TV is 2 hours and 13 minutes, and in the course of playing, if the user finds out that content in the video clip from point-in-time of 1 hour and 40 minutes to point-in-time of 1 hour and 45 minutes is wonderful, extracting buttons on peripheral device can be pressed down at the point-in-time of 1 hour and 40 minutes and the point in time of 1 hour and 45 minutes, respectively. After the control instructions corresponding to the extracting buttons are received, the smart TV can acquire the start time and the end time of extracting a video clip in the corresponding playback progress.

S103: uploading the identity information of the currently playing video and the start time and the end time to a server, so that the server generates a shared link about the extracted video clip, and provides the shared link for a user.

After the start time and the end time of a video to be extracted are acquired, the start time and end time of the video to be extracted as well as the identity information of the video can be uploaded to a server. The identity information of the video can be a name of the video, alternatively, a video background number in the server or the like can be used as the unique identity information of the video. The server can generate the shared link about the extracted video clip after receiving the identity information of the video to be extracted and the start time and the end time, and can provide the shared link for the user. Specifically, the shared link can be sent to the smart TV of the user.

The server may generate the shared link about the extracted video clip in a plurality of implementation manners. For example, first the data content of the current video can be found out according to the identity information of the current video; the data content corresponding to the video clip is extracted from the data content of the current video according to the start time and the end time of video extracting operation, thereby generating an independent video clip file. And then an access address can be generated for the video clip file according to a preset address generation rule at the server and the shared link of the video clip file is generated based on the access address. In this manner, as the video clip file is an individual file and independent of original video file and stored in the server. As time goes on, more and more video clip files are extracted by many users, and the longer time the shared video clip files have been stored, the less opportunity they are shared by the users; for this reason, the video clip files stored in the server can be processed as temporary files. When video clip files have been stored, from the moment of generation, exceed a preset duration threshold, e.g., one week, the video clip files are deleted from the server, thereby preventing excessive video clip files in which almost no one shows interest from being stored in the server and reducing the storage pressure of the server.

In another implementation manner, a link of the current video can be determined by the server according to the identity information of the current video; when the smart TV accesses to a server and plays a video provided by the server through the Internet, it accesses to a video file with network address generally; i.e., each video will corresponds to a network link address on a server. Hence, the link of the current video can be acquired according to the identity information of the current video. Further, information of the start time and the end time of video clip to be extracted can be spliced to the link of the current video to generate the shared link about the extracted video clip. In this manner, when generating the link of a video clip extracted from a video, only the link address of the video needs to be provided, and information of the start time and the end time just needs to be spliced into the provided link address of the video. The generated link of a video clip contains information of the start time and the end time, and an independent file does not need to be re-generated. After the link containing the start time and the end time information is shared with a friend, it can be parsed to obtain information of video contained in the link as well as information of the start time and the end time therein when the link, spliced with information of the start time and the end time, of the video clip is clicked at a client of a sharing recipient. And then a video is played from a video frame corresponding to the start time to a video frame corresponding to the end time.

In this manner, the sharing recipient can watch wonderful video clip according to the link containing information of the start time and the end time. If the sharing recipient is interested in complete video and hopes to watch the complete video containing the video clip at this moment, an operation interface for watching the complete video containing the video clip can be provided in user programs, and when a request for playing the complete video from the beginning is received through the interface, the complete video can be played from the beginning frame of the video.

After the server generates the shared link, the shared link can be returned to a client of a sharing provider. The client of the sharing provider can be installed with a corresponding communication application or system can install in the client of the sharing provider to communicate with friends when the sharing provider logs in. After the client of the sharing provider receives the shared link returned by the server, a friend user list of the current user can be automatically displayed in the application; after the current user has chosen a target friend user, the shared link is automatically input and displayed in a pop-up dialog box, and can be sent to the target friend user by messaging system after the user confirms sending.

The video sharing method in a smart TV according the embodiments of the present application is described in detail above. with this method, the control instruction of extracting a video clip from currently playing video can be received during the course of playing the video in the smart TV, and the start time and the end time of the extracted video clip in the currently playing video are acquired according to the playback progress of the currently playing video when receiving the extracting start instruction and the extracting end instruction, and then the identity information of the currently playing video and the extracting start time and extracting end time are uploaded to a server so that the server generates the shared link about the extracted video clip and provides the shared link for the user. As a result, when the user watches video program through a smart TV, the start time and the end time of any wonderful video clip in a video program can be sent to a server at any moment so that the server generates and returns the shared link of the video clip; the user can share the shared link with any friend, and the friend received the shared link can watch the shared video clip at any moment according to the shared link. Hence, an extremely flexible video sharing method in a smart TV is disclosed.

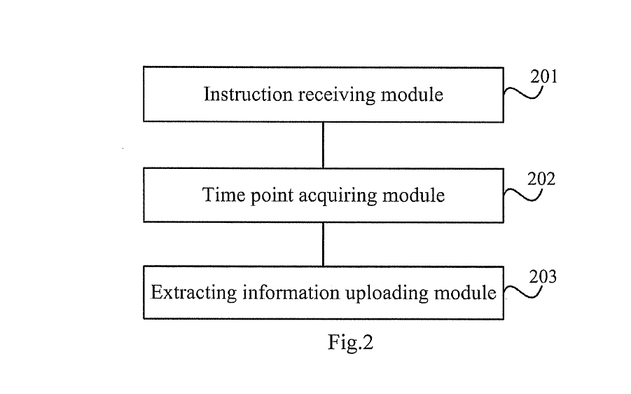

Corresponding to the video sharing method in a smart TV according to the embodiments of the present application, the embodiments of the present application further disclose a video sharing system in a smart TV. Referring to FIG. 2, which is a schematic diagram of a video sharing system in a smart TV according to the embodiments of the present application. As shown in FIG. 2, the system may include:

an instruction receiving module 201 configured to receive a control instruction of extracting a video clip from currently playing video during the course of playing a video in the smart TV, wherein the control instruction includes an extracting start instruction and an extracting end instruction to extract a video clip from the currently playing video;

a time point acquiring module 202 configured to acquire a start time and an end time of an extracted video clip in the currently playing video according to the playback progress of the currently playing video when receiving the extracting start instruction and the extracting end instruction; and

an extracting information uploading module 203 configured to upload the identity information of the currently playing video and the start time and the end time to a server, so that the server generates a shared link about the extracted video clip, and provides the shared link for a user.

The video sharing system in a smart TV may include a server, and the server includes:

a link generation module configured to generate the shared link about the extracted video clip at the server.

The link generation module may include:

a video finding out module configured to find out the data content of the currently playing video according to the identity information of the currently playing video;

a video clip generation module configured to extract the data content corresponding to the video clip from the data content of the currently playing video according to the start time and the end time and generate a video clip file; and

a first link generation module configured to generate an access address for the video clip file according to a preset address generation rule and generate a shared link of the video clip file based on the access address.

In addition, the server included in the video sharing system in a smart TV may include:

a video clip deletion module configured to delete the video clip file from the server when the existence time, from the moment of generation, of the video clip file exceeds a preset duration threshold.

In another implementation mode, the video sharing system in a smart TV may include a server, and the server includes:

a link generation module configured to generate the shared link about the extracted video clip at the server.

The link generation module may further include:

a current video link determination module configured to determine a link of the currently playing video according to the identity information of the currently playing video; and

a second link generation module configured to splice the start time and the end time into the link of the currently playing video to generate the shared link about the extracted video clip.

In this manner, the video sharing system in a smart TV may further include:

a link address parsing and playing module configured to play a video from a video frame corresponding to the start time to a video frame corresponding to the end time when the link, into which the start time and end time are spliced, of the video is clicked at a client of a sharing recipient.

After the sharing recipient watches the video clip and if the sharing recipient is interested in complete video corresponding to the video clip, in order to further provide the complete video, the video sharing system in a smart TV may further include:

a complete video providing module configured to play the complete video from the beginning frame of the video when receiving a request for playing the complete video from the beginning during the course of playing the video clip from the video frame corresponding to the start time.

in addition, the server in the video sharing system in a smart TV may include:

a link returning module configured to return the shared link to a client of a sharing provider after the shared link is generated.

The system may further include:

a friend list display module configured to display a friend user list of current user after the shared link returned by the server is received; and

a video link sending module configured to display the shared link in a pop-up dialog box after the current user chooses a target friend user, so that the shared link is sent to the target friend user by a message system.

The video sharing system in a smart TV disclosed in the embodiments of the present application is described above. With this system, the start time and the end time of any wonderful video clip in a video program can be sent to a server at any moment when the user watches the video program through a smart TV, so that the server generates and returns the shared link of the video clip, and the user can share the shared link with any friend, and the friend received the shared link can watch shared video clip at any moment according to the shared link. Hence, an extremely flexible video sharing system in smart TV is disclosed.

The embodiments of the present application further provide a computer readable storage medium on which a program for executing the above-mentioned method is recorded.

The computer-readable storage medium includes any medium capable of storing or transmitting information in a machine (e.g., computer) readable form. For example, a machine-readable medium includes a read-only memory (ROM), a random access memory (RAM), a disk storage medium, an optical storage medium, a flash storage medium, to store electric, optical, acoustic or other-form propagated signals (such as, carriers, infrared signals and digital signals) and the like.

It shall be noted that each embodiment in the description is described in a progressive manner, and the emphasized descriptions of each embodiment are different from other embodiments, and for the same or similar portions of the various embodiments, reference can be made to each other. With respect to the system embodiments, as they are substantially similar to the method embodiments, their descriptions are relatively simple, and for the correlated portions, reference can be made to part of the descriptions of the method embodiments.

With respect to each above-mentioned method embodiment, for the sake of simple descriptions, each method embodiment is expressed as a series of action combinations; however, those ordinary skilled in the art should know that the present application is not limited to the described action sequence, because some steps can be executed in other sequences or simultaneously according to the present application; secondly, those skilled in the art also should know the method embodiments all are exemplary embodiments, and the actions and modules involved are not always necessary for the present application.

The video sharing method and system in a smart TV provided by the present application are described in detail above. The principle and the embodiments of the present application are explained with specific examples, and the foregoing descriptions of the embodiments are merely used for helping to understand the method of the present application and the central ideas thereof; meanwhile, for those of ordinary skill in the art, variations can be made in the specific embodiments and the application range according to the ideas of the present application. In summary, the content of the description should not be understood as limitations to the present application.

1. A video sharing method in a smart TV, comprising:
during the course of playing a video in the smart TV, receiving a control instruction of extracting a video clip from currently playing video, wherein the control instruction comprises an extracting start instruction and an extracting end instruction to extract a video clip from the currently playing video;
acquiring a start time and an end time of an extracted video clip in the currently playing video according to the playback progress of the currently playing video when receiving the extracting start instruction and the extracting end instruction,;
uploading the identity information of the currently playing video and the start time and the end time to a server, so that the server generates a shared link about the extracted video clip, and provides the shared link for a user.

2. The video sharing method in a smart TV according to claim 1, wherein the server generating the shared link about the extracted video clip comprises:
finding out, by the server, the data content of the currently playing video according to the identity information of the currently playing video;
extracting the data content corresponding to the video clip from the data content of the currently playing video according to the start time and the end time and generating a video clip file;
generating an access address for the video clip file according to a preset address generation rule and generating a shared link of the video clip file based on the access address.

3. The video sharing method in a smart TV according to claim 2, wherein if the existence time, from the moment of generation, of the video clip file exceeds a preset duration threshold, the video clip file is deleted from the server.

4. The video sharing method in a smart TV according to claim 1, wherein the server generating the shared link about the intercepted video clip comprises:
determining, by the server, a link of the currently playing video according to the identity information of the currently playing video;
splicing the start time and the end time to the link of the currently playing video to generate the shared link about the extracted video clip.

5. The video sharing method in a smart TV according to claim 4, further comprising:
playing a video from a video frame corresponding to the start time to a video frame corresponding to the end time when the link, which the start time and end time are spliced into, of the video is clicked at a client of a sharing recipient.

6. The video sharing method in a smart TV according to claim 5, further comprising:
during playing the video from the video frame corresponding to the start time, if a request for playing the complete video from the beginning is received, playing the complete video from the beginning frame of the video.

7. The video sharing method in a smart TV according to claim 1, wherein after the shared link is generated, the server returns the shared link to a client of a sharing provider, the method further comprising:
after the shared link returned by the server is received, displaying a friend user list of current user;
after the current user chooses a target friend user, displaying the shared link in a pop-up dialog box so that the shared link is sent to the target friend user by a message system.

8. A video sharing system in a smart TV comprises a first memory, one or more programs stored in the first memory and one or more first processors, and the first processors are configured with programs stored in the first memory for, comprising:
receiving a control instruction of extracting a video clip from currently playing video during the course of playing a video in the smart TV, wherein the control instruction comprises an extracting start instruction and an extracting end instruction to extract a video clip from the currently playing video;
acquiring a start time and an end time of an extracted video clip in the currently playing video according to the playback progress of the currently playing video when receiving the extracting start instruction and the extracting end instruction; and
uploading the identity information of the currently playing video and the start time and the end time to a server, so that the server generates a shared link about the extracted video clip, and provides the shared link for a user.

9. The video sharing system in a smart TV according claim 8, wherein a server included in the system comprises a second processor and a second memory, where the second memory is configured to store instructions of a computer program and the second processor is configured to execute the computer program to:
generate the shared link about the extracted video clip at the server;
the second processor is configured to:
find out the data content of the currently playing video according to the identity information of the currently playing video;
extract the data content corresponding to the video clip from the data content of the currently playing video according to the start time and the end time and generate a video clip file; and
generate an access address for the video clip file according to a preset address generation rule and generate a shared link of the video clip file based on the access address.

10. The video sharing system in a smart TV according to claim 8, wherein a server included in the system comprises a third processor and a third memory, where the third memory is configured to store instructions of a computer program and the third processor is configured to execute the computer program to:
generate the shared link about the extracted video clip at the server;
the third processor is configured to:
determine a link of the currently playing video according to the identity information of the currently playing video; and
splice the start time and the end time into the link of the currently playing video to generate the shared link about the extracted video clip.

11. A computer-readable storage medium containing executable program instructions which cause a data processing device to perform a video sharing method in a smart TV comprising:
during the course of playing a video in the smart TV, receiving a control instruction of extracting a video clip from currently playing video, wherein the control instruction comprises an extracting start instruction and an extracting end instruction to extract a video clip from the currently playing video;
acquiring a start time and end time of an extracted video clip in the currently playing video according to the playback progress of the currently playing video when receiving the extracting start instruction and the extracting end instruction,;
uploading the identity information of the currently playing video and the start time and end time to a server, so that the server generates a shared link about the extracted video clip, and provides the shared link for a user.

12. The medium according to claim 11, wherein the server generating the shared link about the extracted video clip comprises:
finding out, by the server, the data content of the currently playing video according to the identity information of the currently playing video;
extracting the data content corresponding to the video clip from the data content of the currently playing video according to the start time and the end time and generating a video clip file;
generating an access address for the video clip file according to a preset address generation rule and generating a shared link of the video clip file based on the access address.

13. The medium according to claim 12, wherein if the existence time, from the moment of generation, of the video clip file exceeds a preset duration threshold, the video clip file is deleted from the server.

14. The medium according to claim 11, wherein the server generating the shared link about the intercepted video clip comprises:
determining, by the server, a link of the currently playing video according to the identity information of the currently playing video;
splicing the start time and the end time to the link of the currently playing video to generate the shared link about the extracted video clip.

15. The medium according to claim 14, further comprising:
playing a video from a video frame corresponding to the start time to a video frame corresponding to the end time when the link, which the start time and end time are spliced into, of the video is clicked at a client of a sharing recipient.

16. The medium according to claim 15, further comprising:
during playing the video from the video frame corresponding to the start time, if a request for playing the complete video from the beginning is received, playing the complete video from the beginning frame of the video.

17. The medium according to claim 11, wherein after the shared link is generated, the server returns the shared link to a client of a sharing provider, the method further comprising:
after the shared link returned by the server is received, displaying a friend user list of current user;
after the current user chooses a target friend user, displaying the shared link in a pop-up dialog box so that the shared link is sent to the target friend user by a message system.
